(19) United States
(12) Patent Application Publication
(10) Pub. No.: US 2008/0317633 A1
(43) Pub. Date: Dec. 25, 2008

(54) Multiplex lateral flow devices and methods

(75) Inventors: Scott S. Sibbett, Corrales, NM (US); Gabriel P. Lopez, Albuquerque, NM (US)

Correspondence Address: Mr. Edward J. Timmer, P.O. Box 770, Richland, MI, 49083-0770, US

(73) Assignee: STC.UNM

(21) Appl. No.: 12/150,607

(22) Filed: Apr. 29, 2008

Related U.S. Application Data
(60) Provisional application No. 60/926,871, filed on Apr. 30, 2007.

(51) Int. Cl. B01J 19/00; B32B 38/10; B32B 38/00; B32B 38/18

(52) U.S. Cl. 422/68.1; 156/250; 156/247; 156/281; 156/190

(57) ABSTRACT

A lateral flow device includes a porous medium layer having a two-dimensional shape in plan view defined by one or more peripheral edges wherein the two dimensional shape includes a plurality of testing regions separated from one another by spaces between portions of the one or more peripheral edges. The porous medium layer further includes a fluid-receiving region in capillary flow communication through the porous medium layer to the testing regions.

This application claims benefits and priority of provisional application Ser. No. 60/926,871 filed Apr. 30, 2007, the disclosure of which is incorporated herein by reference.

### FEDERALLY SPONSORED RESEARCH

The present invention was made with government support under Grant No. CTS0332315 awarded by the National Science Foundation. As a result, the Government may have certain rights in this invention.

### BACKGROUND OF THE INVENTION

1. Field of the Invention

This invention relates to lateral flow devices and, more particularly, to lateral flow devices and methods of manufacture wherein a porous medium layer is cut having a preselected two dimensional shape in plan view and defined by one or more peripheral cut edges. The devices are useful in diffusional, multiphase contacting, and separation operations. More specifically, the devices are useful in various chemical and biochemical assays, including lateral flow test strips.

2. Description of the Prior Art

All commercially-available lateral flow test strips today are rectangular in shape, and comprised of one or more layers of porous material (FIG. 1). When wetted with an analyte-containing liquid (usually aqueous), the porous material provides a motive force for the movement of bulk liquid from wet to dry areas of the strip. The main motive force is capillary action. This flow of bulk fluid enables a controlled movement of analyte across specific, well-defined segments of the test strip which have been previously modified to contain various color-forming reagents. In general, a typical state-of-the-art lateral flow test strip expresses a line of a certain color only in the presence of the analyte. For example, a state-of-the-art lateral flow test kit is sold by Quidel Corporation under the brand name QuickVue. The QuickVue test allows for the rapid, quantitative detection of influenza type A and type B antigens directly from a nasal swab specimen. The test involves the extraction of the antigens by the following procedure. First, the nasal swab specimen is obtained by inserting a sterile swab inside the patient's nose, and gently rotating. The swab is then inserted into a test tube containing approximately 5 mL of solution which disrupts viral particles in the specimen, thereby exposing internal viral nucleoproteins. The swab is removed from the test tube. A lateral flow test strip is then inserted into the test tube, contacting the solution in the test tube and causing the analyte nucleoproteins to be swept with the bulk fluid, by capillary action, from the wetted region of the strip to the dry region. As the nucleoproteins are swept along, they pass regions of the strip which are precoated with certain specific chemicals. For example, in a double antibody sandwich reaction scheme, free antigen (viral nuceloprotein) encounters a labelling region which is pre-coated with an antibody/colored-microsphere complex. Due to a high affinity constant, effectively all antigen binds with a complex molecule, and the resulting antigen-antibody/colored-microsphere complex is then carried by capillary action to another region, which is precoated with a second antibody that is specific for a second antigenic site on the viral nucleoprotein. The second antibody is covalently bound to the site, hence any passing antigen-antibody/colored-micro sphere complex is captured in the region. In the absence of free antigen in the original patient specimen, the antibody/colored-microsphere complex is not bound at the second region, but, for control purposes, is captured at a third region pre-coated with antibody for antibody/colored-microsphere complex. This third region also captures any excess antibody/colored-microsphere complex molecules. Hence, at the conclusion of a positive test, color forms at both the second and third “test indicator” regions; whereas at the conclusion of a negative test, color forms only at the third region. Other reaction schemes exist; e.g., the competitive reaction scheme, the “Boulders-in-a-stream” reaction scheme, etc. But the standard format of these and all other lateral flow tests is a rectangular lateral flow test strip. In some cases, the rectangular strip is encased in a plastic cassette to enhance the reproducibility of fluidic control, minimize operator error, mechanically clamp various components of the strip, etc. But in all cases the basic format and operation of the state-of-the-art lateral flow test strip is a rectangle of porous media, wetted at one end to drive bulk fluid by capillary action through regions precoated with certain chemicals, which in turn, directly or indirectly signal the presence or absence of a given analyte.

### Limitations of the Prior Art

The following limitations exist for state-of-the-art lateral flow test strips:

1. Virtually all test strips are monoplex, i.e., only one analyte, or family of chemically- or immunologically-equivalent analytes, are analyzed per test.

In theory, multiple analytes could be tested simultaneously on a single test strip simply by pre-coating regions with multiple chemical and/or immunological reactants. But practically, this approach is hampered by: (i) the increased likelihood of misinterpreting results when multiple lines are to be inspected; (ii) the increased difficulty of fabricating test strips with multiple reaction and control lines; (iii) the increased difficulty of fabricating test strips in which no two lines appreciably overlap; (iv) the increased likelihood of analytical interference of one analyte by another; and (v) the challenge of identifying a set of immunologicals which are analytically specific yet unhampered by cross-reaction of the analytes being measured. To overcome these limitations, the state-of-the-art for routine multiplex analysis of biologicals is microarray analysis via assays such as electrochemiluminescence (ECL) immunoabsorption, ECL functional/enzymatic assay, or Luminex/Bioplex-based ELISA on coded beads. To date, no multiplex lateral flow test strips are known to have been brought to market.
2. Test strips are often used in conjunction with a cassette to ensure proper operation.

The cassette is necessary to obtain proper clamping of the various components of the strip, to obtain proper fluidic control, to minimize operator error, etc. The cassette adds to the cost of a test. It is a typical source of problems. Most problems have one of two origins: (i) incorrect design or fabrication of the cassette (a common problem in the current era of a proliferation of small biotech company start-ups); and/or (ii) the test strip has been incorrectly positioned within the cassette (a common user error of even commercially-available products). With regard to bioassays based on lateral flow test strips, these problems typically result in false positive and false negative results.
3. Many test strips are fabricated with the reaction and control lines directly exposed to the ambient.

This introduces potential errors due to contamination of the exposed porous media or reacting chemicals. Such contamination may occur as a result of ambient pollutants, the outgassing of plasticizer from tests strips and their packages, and fingering of the porous media surface by users manipulating test strips. These and other such contaminating steps can leave hydrophobic residues on the surface of the porous media, thus altering the proper flow characteristics of the test strip. In the case of gross contamination by a substance unrelated to the test, as might occur as a result of a blunder, the performance of the test strip may possibly be prevented. Also, a typical porous media surface such as nitrocellulose is hygroscopic, therefore the capillary activity of the nitrocellulose is altered by changes in ambient humidity. A typical nitrocellulose test strip is delivered to the user in a hermetically-sealed Mylar package. Typically, the package is necessary to ensure that the nitrocellulose has been equilibrated at the factory to an atmosphere of relative humidity 50% plus or minus 5%, and then delivered to the user at this same humidity. This produces consistent flow properties of a fresh test strip, regardless of whether the user resides in a region of high or low relative humidity.
4. Test strips are prone to flooding of analyte solution, especially when used in conjunction with a cassette.

The term “flooding” is used here to mean bulk convective flow of analyte solution across the top surface of the test strip. Flooding is deleterious to the proper functioning of the strip, since the overwhelming quantity of fluid passes on, not through, the chemically-pre-coated regions of the porous medium. To minimize this effect, the Quidel test strip described above prescribes a vertical orientation of the test tube. This eliminates gravity-fed flow up the strip. Hence, capillary-fed flow is the only major force which causes fluid to move up the strip. But the test tube does not preclude splashing of solution directly to the exposed porous medium.

A common alternate strategy to minimize flooding is to encase the test strip in a horizontally-oriented cassette which has been fabricated to include a via (inlet) where analyte solution is loaded onto the test strip. The via performs two functions: (i) it controls the location of contact of solution onto the test strip; and (ii) in theory, it controls flooding. The presumed control of flooding arises because the the lower surface edge of the via is designed to be in intimate physical contact with the upper surface of the test strip. Hence, in theory, bulk fluid flow is prevented from crossing the surface of the test strip beyond the via; in effect, the via is intended to serve as a sort of pipe. In practice, however, the via: (i) may not always seat firmly or completely with the top surface of the test strip, thereby exposing gaps through which bulk fluid flow of analyte solution may pass; and (ii) is usually contacted with a conjugate pad fabricated of glassy fiber of high porosity, offering, by design, little or no resistance to bulk fluid flow. Even in the case of perfect physical contact between the via edge and a low-porosity surface, hydrostatic pressure exists from solution in the via, to the surface of the test strip. This may drive solution flow through the porous medium at a rate more or less comparable in velocity to the rate of flow driven by capillary action, thereby altering the flow properties of the test strip. Also, a typical cassette also contains a second via which serves as a peep hole for the user to observe the development of color at the reaction and control lines. Nothing prevents the user from erroneously placing or splashing analyte solution into this hole. The use of a cassette adds to the cost of a test, and to the complexity of the procedure of the test.

### SUMMARY OF THE INVENTION

The present invention relates to lateral flow devices and methods of manufacture wherein a porous medium layer is cut to have a two-dimensional shape in plan view defined by one or more peripheral edges of the porous medium layer and wherein the two dimensional shape includes a plurality of fluid testing regions separated from one another by intervening spaces between portions of the one or more peripheral edges. The porous medium layer includes a fluid-receiving region in capillary flow communication through the porous medium layer to the fluid testing regions. The fluid-receiving region can reside on the porous medium layer on the two dimensional shape, on a portion of a peripheral edge, or on both.

In an illustrative embodiment of the present invention, the fluid testing regions comprise a plurality of elongated arms which can be of various shapes. The arms have deposited thereon a respective bioreagent, immunological reagent, and/or chemical reagent for detecting the presence or absence of an analyte in the fluid. A fluid sample introduced to the fluid-receiving region flows by capillary action through the porous medium layer toward each of the plurality of fluid testing regions where a plurality of assays can be performed on the fluid sample.

The porous medium layer can have various two dimensional shapes in plan view that include, but are not limited to, a star or spoke shape in plan view with a fluid-receiving central region from which a plurality of fluid testing arms extend and are separated from one another by intervening spaces between portions of outer peripheral severed edges; a candelabra or tree shape in plan view with a fluid-receiving base and a plurality of candelabra or tree fluid testing arms connected to the base to which fluid flows by capillary action; and a double candelabra shape in plan view with first fluid-sample receiving base connected to a plurality of candelabra fluid testing arms which are connected to one another and to a second base and wherein fluid flows from the first fluid sample-receiving base and through the candelabra arms to the second base by capillary action. The candelabra fluid testing arms are separated from one another by intervening spaces between portions of inner peripheral severed edges of the two dimensional shape.

### DESCRIPTION OF THE DRAWINGS

FIG. 1 is a perspective view of layers of a lateral flow device, both in exploded view, and in a view depicting an as-assembled laminar composite.

FIG. 2 is a plan view of a 4-arm star shaped device.

FIG. 3 is a perspective view of the 4-arm star shaped device.

FIG. 3a is a perspective view of a 4-arm star shaped device having arms of different length.

FIG. 4 is plan view of an 8-arm star shaped device.

FIG. 5 is plan view of a 8-arm branching star shaped device.

FIG. 6 is plan view of a 16-arm branching star shaped device.

FIG. 7 is plan view of a 5-arm candelabra device.

FIG. 8 is plan view of a 5-arm branched candelabra device.

FIG. 9 is plan view of a 5-arm double candelabra device.

FIGS. 10a and FIG. 10b are plan views of different two dimensional shaped Type 1 devices.

FIG. 11a through 11g are plan views of different Type 2 devices.

FIG. 12a through 12c are plan views of different Type 3 devices.

FIG. 13a and FIG. 13b are plan views of Type 3 devices having symbols on the arms.

FIG. 14 is plan view of a lollipop arm and FIG. 15 is plan view of a drooping lollipop arm.

FIG. 16a is a schematic diagram of a method of making a Type 1 device.

FIG. 16b is a schematic diagram of a method of making a Type 2 device.

FIG. 16c is a schematic diagram of a method of making a Type 3 device.

FIG. 16d is a schematic sectional view of the Type 3 device taken through the via.

FIG. 17 is a schematic diagram of an alternative method of making a Type 2 device.

FIG. 18 is a plan view of a two dimensional porous medium shape tested as a Type 2 device and a Type 3 device.

### DETAILED DESCRIPTION OF THE INVENTION

An embodiment of the present invention involves fabrication of lateral flow devices that are shaped in two dimensions in plan view by severing of a porous medium layer and optional fluid-impermeable cover layers to provide multiplex lateral flow assays. The porous medium layer and optional cover layers can be severed by mechanically kiss-cut or through-cut by knife edge, mechanical die cutting, laser beam cutting, punching, perforating, perforating and tearing along perforations, or other severing techniques to sever through at least the porous medium layer and optionally the cover layers.

In an illustrative embodiment of the invention, the severing preferably is computer controlled (e.g. X-Y computer control) to provide a myriad of two dimensional cut shapes including, but not limited to, star, spoke, candelabra, tree, double candelabra and other shapes that have a plurality of fluid testing regions that are peripherally separated from one another by intervening spaces between portions of one or more peripheral edges used to define the two dimensional shape and that can be spotted with (deposited) multiple bioassay or other assay reagents to produce multiplex lateral flow assays.

The porous medium layer can be backed by a protective fluid-impermeable layer and also can be sandwiched between protective fluid-impermeable layers to provide a laminar composite lateral flow device. This minimizes evaporation and protects the devices from contamination and dehydration. The protective films also circumvent the need for the conventional hard plastic cassette holders that are typically used to package commercial lateral flow diagnostic strips, thereby reducing cost per device and simplifying manipulations by users in the field. The lateral flow devices pursuant to the present invention do not require pumps, syringes, filters, electric power supplies or other ancillary devices since they employ capillary action to drive analyte-containing fluids to specific bioreagent, immunological reagent, or chemical reagent lines, dots, spots, etc. on a given testing region of the two dimensional shape.

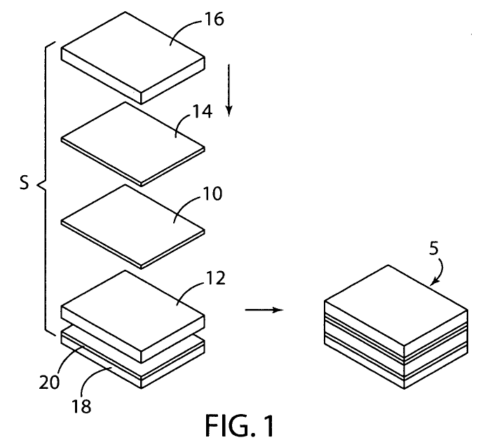

Referring to FIG. 1, films or layers of a laminar composite material suitable for making a lateral flow device pursuant to an embodiment are shown comprising a porous medium sheet or layer 10 backed by an optional fluid-impermeable backing sheet or layer 12 and optionally sandwiched between top and bottom fluid-impermeable plastic sheets or layers 16 and 18. The top layer 16 has hydrophillic adhesive 14 on the side facing the porous medium layer 10. The bottom layer 18 can have an adhesive layer 20 of thereon. The porous medium layer 10 can comprise nitrocellulose, chromatography paper, or other porous material that exhibits fluid capillarity. For purposes of illustration and not limitation, the porous medium layer 10 and backing layer 12 can comprise a two (2) mil clear (transparent) polyester-backed sheet of Hi-Flow Plus 135 nitrocellulose membrane (no. HF13502XSS) commercially available from Millipore Corp., Billerica, Mass. Alternately, chromatography paper commercially available as Whatman Chr 1 (no. 3001-861) from Whatman plc, Kent, United Kingdom, can be used as the porous medium layer 10 and optionally backed by backing layer 12. The fluid-impermeable plastic sheets or layers 16 and 18 both can comprise transparent vinyl cover tape with hydrophilic adhesive (no. GL-166-clear) available from G&L Precision Die Cutting, Inc., San Jose, Calif., USA.

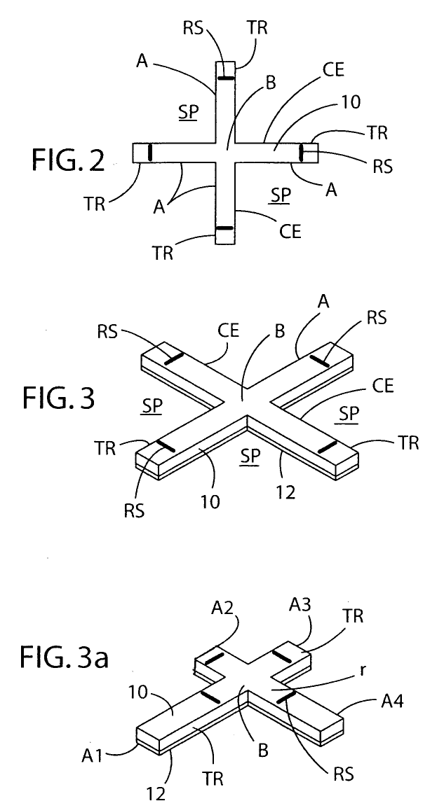

For purposes of illustration and not limitation of the present invention, two dimensional shapes of the porous medium layer and optional cover layers are now described with respect to FIGS. 2 through 13a, 13b. In FIG. 2, the porous medium layer 10 backed by layer 12 is illustrated having a so-called star (or spoke) shape in plan view with a centrally located fluid-receiving region B and a plurality of arms A extending from the fluid-receiving region B and terminating in a plurality of distal testing regions TR to which fluid flows by capillary action. FIG. 3 is a perspective view of the star shape porous medium layer 10 backed by backing layer 12. The two-dimensional shape in plan view of the porous layer medium 10 and backing layer 12 is defined by a peripheral severed (e.g. cut) edge or edges CE of the porous medium layer. The plurality of testing regions TR are separated from one another by intervening spaces SP between facing portions of the outer peripheral severed edge or edges CE if more than one cut is made through the porous medium layer. The fluid-receiving region B is in capillary flow communication through the porous medium layer 10 to the testing regions TR. In FIG. 3, the testing regions TR are shown each including a reagent material RS, such as a respective bioreagent stripe, immunological reagent stripe, or chemical reagent stripe deposited on the testing regions TR for detecting the presence or absence of an analyte. Various types of known reagent materials can be used in practice of the invention depending on the analyte(s) to be detected and are described in U.S. Pat. Nos. 4,855,240; 4,943,522; 4,960,691; and 5,766,961 and others. Multiple reagent materials can be deposited on each testing region TR and can include, but are not limtied to, a labeling reagent, a capturing reagent material, and a control reagent material arranged in sequence on each arm A. The reagent material can be deposited in any suitable shape, such as the stripes shown, dots, spots, or other configuration to suit a particular bioassay or other testing application.

The fluid-receiving region B is adapted to receive a fluid sample containing one or more analytes to be detected or not. The fluid-receiving region B may be untreated or treated depending on the particular fluid to be received and analyte to be detected. For example, to introduce conjugate into a lateral flow assay, the invention envisions an optional additional fabrication step in which reagent materials are deposited directly at fluid receiving region B or other the point of entry of analyte solution, e.g., at the edge of a Type 2 lateral flow device described below where porous media is exposed to the ambient, or within a fluid reservoir of a Type 2 or Type 3 lateral flow device described below. Reagent materials may be deposited at these regions by various methods, including deposition in liquid form followed by air drying resulting in a patch of dried reagent at the point of deposition, or as a solid in the form of powders, particles, beads, etc.

For the star shape shown in plan view in FIGS. 2-3, the star shape has “n” number of arms wherein “n” or more assays can be performed, one or more assay on each of the “n” arms. For example, the star shape has four arms arranged 90 degrees from one another about the fluid-receiving B and wherein four assays can be performed on the arms on one fluid sample introduced to fluid-receiving region B.

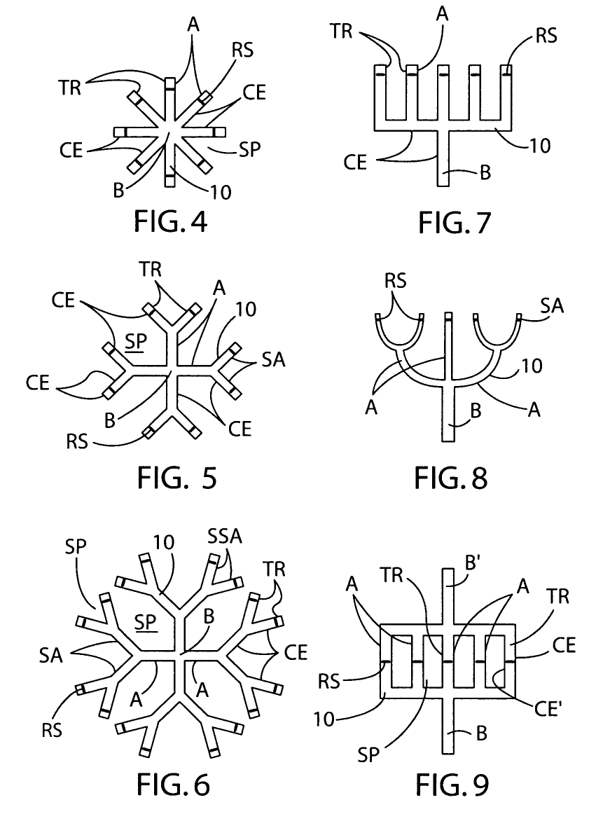

For further illustration, FIG. 4 illustrates in plan view a star shape having eight arms arranged 45 degrees from one another about the fluid-receiving B and wherein eight or more assays can be performed on the arms on one fluid sample introduced to fluid-receiving region B. The two-dimensional shape of FIG. 4 is defined by the outer peripheral severed (e.g. cut) edges CE of the porous medium layer 10. The plurality of testing regions TR are separated from one another by intervening spaces SP between facing portions of the outer peripheral edge(s) CE.

FIG. 5 illustrates in plan view a star shape wherein each arm A includes a plurality of branches forming a plurality of sub-arms SA extending from a respective arm A to which fluid flows by capillary action. The branched star shape includes “m” sub-arms (e.g. eight subarms) and wherein “m” number of assays can be performed on the sub-arms SA on one fluid sample introduced to fluid-receiving region B. The two-dimensional shape of FIG. 5 is defined by the outer peripheral edge(s) CE of the porous medium layer 10. The plurality of testing regions TR are separated from one another by intervening spaces SP between facing portions of the outer peripheral edge(s) CE.

The subarms SA themselves can be provided with a plurality of secondary sub-arms SSA as illustrated in FIG. 6 where the star shape includes a plurality of branches forming a plurality of sub-arms SA extending from a respective arm A and wherein the sub-arms each has a plurality of secondary sub-arms SSA extending therefrom to which fluid flows by capillary action. The two-dimensional shape of FIG. 6 is defined by the outer peripheral severed (e.g. cut) edge(s) CE of the porous medium layer 10. The plurality of testing regions TR are separated from one another by spaces SP between facing portions of the outer peripheral edge(s) CE.

This double-branched star shape includes “p” secondary sub-arms (e.g. sixteen secondary subarms) and wherein “p” number of assays can be performed on the secondary sub-arms SSA on one fluid sample introduced to fluid-receiving region B.

In FIG. 7, a so-called candelabra shape in plan view is illustrated with a fluid-receiving base B and a plurality of candelabra arms A (e.g. five arms) connected to the base to which fluid flows by capillary action so that five assays can be performed on the arms A on one fluid sample introduced to fluid-receiving region B. The two-dimensional shape of FIG. 7 is defined by the outer peripheral edge(s) CE of the porous medium layer 10. The plurality of testing regions TR are separated from one another by intervening spaces SP between facing portions of the outer peripheral edge(s) CE.

FIG. 8 illustrates in plan view a candelabra shape wherein certain arms A include a plurality of branches forming a plurality of sub-arms SA extending from a respective arm A to which fluid flows by capillary action from the fluid-receiving base B. The branched candelabra shape includes a plurality of “r” arm A/sub-arms SA (e.g. five) and wherein “r” number of assays can be performed on the arm/sub-arms on one fluid sample.

FIG. 9 illustrates in plan view the porous medium layer 10 having a double candelabra shape in plan view with first fluid-sample receiving base B connected to a plurality of candelabra arms A which are connected to one another and to a second base B′ and wherein fluid flows from the one fluid sample-receiving base B and through the candelabra arms A to the other of the first and second bases B′ by capillary action. The two-dimensional shape of FIG. 9 is defined by the outer peripheral severed edge(s) CE of the porous medium layer 10 and by inner peripheral severed edges CE′ between the arms A. The plurality of testing regions TR are separated from one another by intervening spaces SP between facing portions of the inner peripheral edge(s) CE′. The double candelabra shape includes five arms where bioassays can be performed on one fluid sample introduced to base B.

In FIGS. 7-9, the fluid containing one or more analytes to be detected can be introduced on the base B by placing a fluid sample on the top surface of the base B using a pipette or other fluid dispensing device or by immersing the base B in the fluid residing, for example, in a test tube. The same immersion technique can be used for the star shapes of FIGS. 2-6 where an arm A of the two dimensional shape of the porous medium layer 10 is immersed in the fluid containing one or more analytes to be detected.

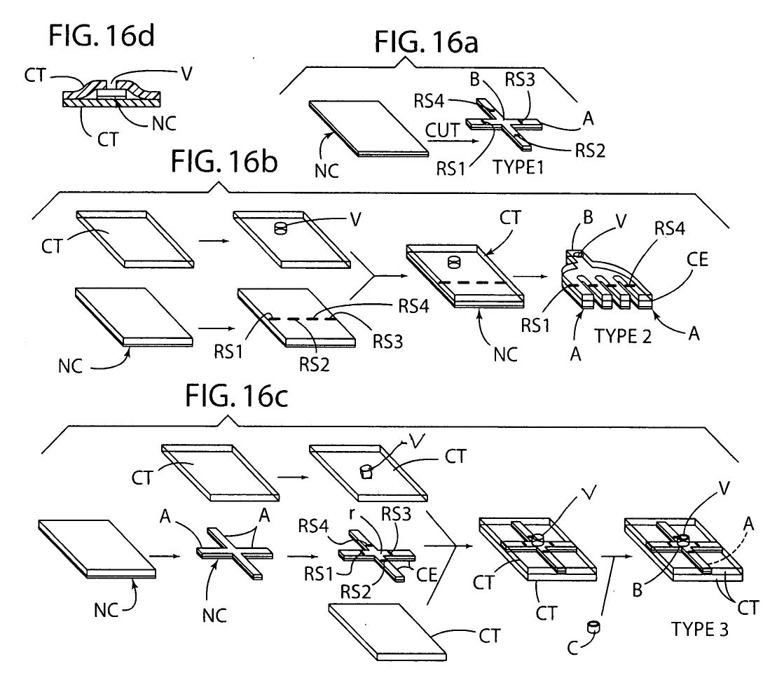

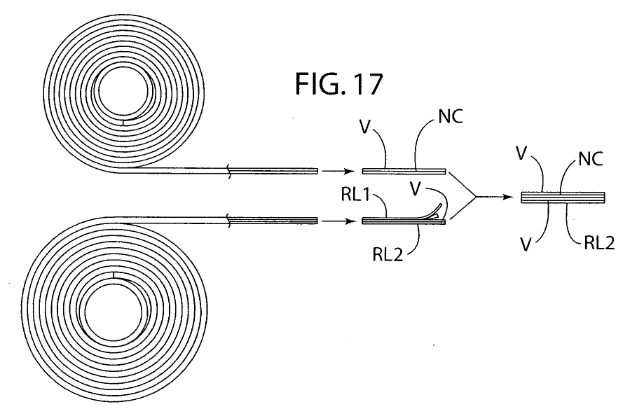

For purposes of further illustration and not limitation, the following EXAMPLES are offered with reference to FIGS. 16a, 16b, and 16c-16d to illustrate different types of lateral flow devices fabricated pursuant to the invention; namely, Type 1, Type 2, and Type 3 lateral flow devices to be described below.

### EXAMPLES

The chemicals and materials employed were as follows: Two mil clear polyester-backed sheets of Hi-Flow Plus 135 porous nitrocellulose membranes (no. HF13502XSS) were from Millipore Corp., Billerica, Mass.. The polyester-backed porous nitrocellulose sheets are designated NC in FIGS. 16a, 16b, and 16c-16d. Chromatography paper was Whatman Chr 1 (no. 3001-861) from Whatman plc, Kent, United Kingdom. Transparent vinyl cover tape with hydrophillic adhesive (no. GL-166-clear) was from G&L Precision Die Cutting, Inc., San Jose, Calif., USA. Bovine serum albumin, glucose oxidase peroxidase and tetrabromophenol blue were from Sigma-Aldrich Co. The fabricated Type 2 and Type 3 lateral flow devices described below were stored at room temperature prior to the testing described below.

In the EXAMPLES set forth below, cutting of the two dimensional shape of each polyester-backed nitrocellulose sheet NC or each sheet of chromatography paper, as well as backing layer and cover layers employed, was achieved using a computer-controlled X-Y cutting plotter that incorporated a knife in place of the traditional ink pen. The X-Y plotter was a Graphtec FC700075 cutting plotter from Western Graphtec Inc., Irvine, Calif. and provided motion of the sheet NC in the y direction by rollers of the plotter and in the x direction by knife carriage motion. The knife was provided by the manufacturer of the cutting plotter and rotated freely on a turret where the traditional ink pin would reside, enabling precise cutting of various features, including small-radius corners or holes. By appropriate adjustment of knife blade angle and downward force, polyester-backed nitrocellulose NC was readily cut with a single pass. However, complete cutting of fiber-containing media, such as the chromatography paper, required up to 3 sequential overlapping cuts, each of which penetrated only partway (‘kiss cuts’) through the porous medium or laminar composite to be described below. Kiss cuts were also employed in cutting fluidic inlet holes (‘vias’) in laminar composites to be described below. Following cutting operations, the removal of unwanted material (‘weeding’) was performed manually. One-time-only instrument set-up required about 60 sec. The actual cutting of each device took 5-15 sec, depending on the nature of the porous medium to be cut and the complexity of the shape. Weeding (removal) of the two dimensional shapes from the polyester-backed nitrocellulose sheet, if needed, took an additional 10-100 sec. The knife plotter can be programmed to cut multiple devices from single sheets up to about 1 m in width, and of unlimited length.

Three different device types were fabricated from the polyester-backed nitrocellulose sheets NC, as depicted schematically in FIGS. 16a, 16b, and 16c-16d.

### Type 1 Lateral Flow Device

The Type 1 lateral flow device illustrated in FIG. 16a was fabricated by cutting the polyester-backed nitrocellulose sheet NC as received from the manufacturer using the computer controlled X-Y plotter described above with the knife blade installed. The entire top surface of the two dimensional star shaped-device consisted of exposed nitrocellulose layer. Reagent stripes RS1, RS2, RS3, RS4 to be described below were then deposited manually by pipet, or mechanically by a computer-controlled reagent dispenser such a Biodot dispenser sold by Bidot Corporation (Irvine, Calif.). These reagent strips are deposited on the respective arms A of the star shape lateral flow device, FIG. 16a, to provide a lateral flow device for multiplex assays.

A modified Type 1 lateral flow device can be obtained by cutting unbacked nitrocellulose sheet NC as received from the manufacturer using the computer controlled X-Y plotter described above with the knife blade installed such that the entire two dimensional star shaped lateral flow device consisted of exposed nitrocellulose layer, i.e., the polyester backing is not present. To cut unbacked sheets of nitrocellulose or chromatography paper, the sheet is first mated with a more rigid temporary substrate, as for instance by the following method: an overhead projector transparency is lightly coated with a contact adhesive, upon which is placed a sheet of Glad Press'n Seal (Glad Products Company) with the non-sticky side of the Press'n Seal facing the contact adhesive. A sheet of nitrocellulose or chromatography paper is then placed on the Press'n Seal, and thereby held in place by the weakly-adhering glue on the sticky side of the Press'n Seal. The resulting laminar composite is then cut in the desired two dimensional shape such as the star shape employed in FIG. 16a. Release of the desired shape is achieved by weeding of unwanted material, and final delamination of the nitrocellulose or chromatography paper from the Press'N Seal-overhead transparency composite. Alternate methods of cutting unbacked nitrocellulose or chromatography include scissors, die-cutting, laser, etc.

The Type 1 lateral flow devices described above are suited for incorporation in conventional lateral flow assay hard plastic cassettes. Alternatively, they may be used simply by placing them on a surface with the plastic-backing-side-down; i.e. backing layer 12 on the surface.

### Type 2 Lateral Flow Device

The Type 2 lateral flow device illustrated in FIG. 16b was fabricated by mating a sheet of the cover tape (layer) CT described above with the polyester-backed nitrocellulose sheet NC upon which reagent stripes RS1, RS2, RS3, RS4 previously have been deposited on the nitrocellulose layer by manual or mechanical means described above. The adhesive side of the cover tape CT was mated with the reagent-bearing side of the nitrocellulose sheet NC. An optional fluidic inlet or via V (FIG. 16b) can be incorporated in either of two ways: either (1) prior to mating of the nitrocellulose sheet with cover tape, an inlet hole is cut into the cover tape by various means, such as the computer-controlled X-Y knife cutting plotter, die-cut, laser, etc.; or (2) after mating of the nitrocellulose sheet with cover tape, an inlet hole is kiss-cut into the cover tape by a computer-controlled X-Y knife plotter, followed by weeding of the interior portion of cover tape within the kiss-cut hole. The resulting laminar composite of sheet NC and cover tape (layer) CT was then cut into the final two-dimensional candelabra shape by the computer-controlled knife plotter to provide a lateral flow device with four arms for multiplex assays. Ambient air occupies the intervening spaces SP between adjacent arms A. An optional cylinder or tube (not shown in FIG. 16b but see FIG. 16c) may be affixed by glue or other means over the optional via V shown in FIG. 16c, thereby providing a macroscale reservoir for the fluid-receiving base B.

The Type 2 device thus comprised polyester-backed nitrocellulose sheet NC or chromatography paper capped with vinyl cover tape (layer) CT, which is then two-dimensionally shaped by cutting to the desired shape. The resulting shaped laminar composite presents exposed nitrocellulose along the entire outer peripheral cut edge CE, and/or at inlet via V, if present. When contacted by fluid at the via V, the exposed nitrocellulose is immediately and spontaneously wetted by capillary action.

An alternative method of fabrication is provided for web-based high-volume manufacturing of Type 2 lateral flow device as follows.
1. As illustrated in FIG. 17, a laminar composite of the following is fabricated via conventional web-based methods: top layer comprising a release liner RL1 with adhesive of low-adhesive strength; a middle layer comprising a vinyl layer V coated on one side with a hydrophilic adhesive of relatively strong adhesive-strength and an adhesive of relatively strong adhesive-strength on the other side; a bottom layer equivalent in composition to RL1 designated RL2 wherein the whole laminar composite is designated RL1/V/RL2.
2. A web of RL1/V/RL2 is wound on a spool.
3. A second laminar composite of the following is fabricated via conventional web-based methods: top layer comprising a vinyl layer (cover tape) V and a bottom layer comprising a thin-film of porous nitrocellulose or other porous medium 10, wherein the structure is equivalent to, for example, Millipore HiFlow Plus from Millipore Corp., Billerica, Mass. and designated NC.
4. A web of NC is wound on a spool.
5. By machine or other methods, the two reels are simultaneously unwound: (i) RL1 is peeled off of RL1/V/RL2, RL1 is discarded, resulting in a web of V/RL2; (ii) V/RL2 is then mated to NC, such that the porous-media-bearing side of NC is mated to the hydrophilic-adhesive-bearing side of V/RL2, resulting in a laminar composite designated NC/V/RL2.
6. The composite NC/V/RL2 is then cut by mechanical or other means into two dimensional device structures such as those described above (e.g. star shapes, etc.). To fabricate devices useful for performing chemical or biochemical assays, it is necessary to incorporate conventional chemical or biochemical dispense steps into the methods of fabrication described above. These dispense steps can be performed manually or by machine (e.g., dispense machines sold by Biodot Inc. and other companies).

The Type 2 lateral flow devices can be used in the cassette-less mode and thus circumvent the need for a hard plastic cassette.

### Type 3 Lateral Flow Device

The Type 3 lateral flow device illustrated in FIGS. 16c-16d was made by initially cutting a polyester-backed nitrocellulose sheet NC using the knife cutting plotter into a two-dimensional form shown as a star shape in FIG. 16c. The arms A of the star shaped polyester-backed nitrocellulose shape were then spotted with reagent stripes RS either manually with a pipet or, by a machine-based reagent dispenser. The star shape then was manually sandwiched between two sheets of cover tape (layer) CT described above such that portions of the cover tapes CT occupy the intervening spaces SP between adjacent arms A. An optional cylinder C may be affixed by glue or other means over the via(s) V, thereby providing a macroscale reservoir for the fluid-receiving base B.

The Type 3 lateral flow device thus is a Type 2 device that has been further covered with the cover tape CT such that all or part of the peripheral cut CE edge of nitrocellulose (or chromatography paper) is covered.

Fluidic access to the nitrocellulose star shape was provided by one of three methods: (i) one or more inlet vias V are cut in the top cover tape CT as shown in FIG. 16c-16d; (ii) a cross-section of the laminar composite is exposed by knife blade, scissors, laser, die-cut or other means, thereby opening to the ambient a peripheral cut edge CE of the nitrocellulose layer NC; or (iii) the dimensions of the capping (top) cover tape CT are appropriately adjusted such that, upon mating with nitrocellulose shape NC, the cover tape falls just short of fully capping the entire exposed surface of the nitrocellulose layer. The one or more vias in the top surface of the cover tape CT can be fabricated by one of two methods: (i) using the computer-controlled knife plotter, a sheet of cover tape is pre-cut with a hole, FIG. 16c, and mated with two dimensionally shaped nitrocellulose to form a laminar composite; or (ii) a circular kiss cut is made in the cover tape CT of a shaped laminar composite, followed by manual release of the newly cut circular portion to reveal an opening through the remaining intact cover tape CT.

The Type 3 lateral flow devices can be used in the cassette-less mode and thus circumvent any need for a hard plastic cassette.

For each of the Type 1, Type 2, and Type 3 lateral flow devices made as described above, a fluid comprising a conventional aqueous dye was observed to migrate from the fluid-receiving region B through the porous nitrocellulose or chromatography paper in a uniform fashion regardless of the complexity of the device shape, size or type.

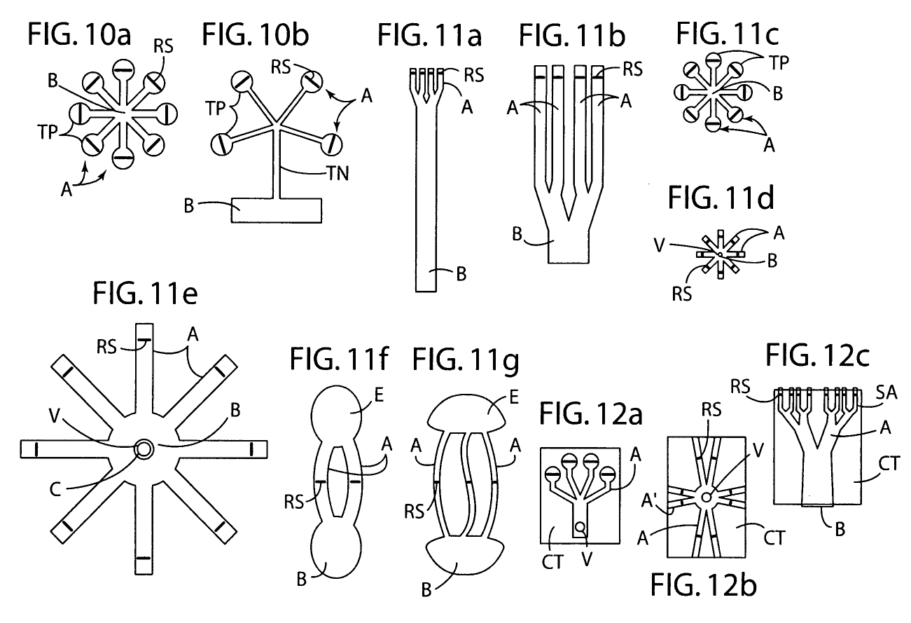

Referring to FIGS. 10a and 10b, further illustrative Type 1 lateral flow devices pursuant to the invention made as described above in the EXAMPLES are shown by cutting of polyester-backed nitrocellulose sheet. The Type 1 lateral flow device of FIG. 10a comprises a two dimensional star shape in plan view with fluid-receiving region B and a plurality of arms A that terminate with circular testing pads TP where reagent material RS can be deposited as stripes, dots or other configurations to provide a multiplex assay device. Reagent material RS also can be deposited on the narrow part of the arms A inwardly of the testing pads TP. The Type 1 lateral flow device of FIG. 10b comprises a two dimensional tree shape in plan view with fluid-receiving region B and a plurality of arms A that extend from a tree trunk TN and terminate in integral circular testing pads TP where reagent material RS can be deposited as stripes, dots or other configurations to provide a multiplex assay device.

Referring to FIGS. 11a, 11b, 11c, 11d, 11e, 11f, and 11g further illustrative Type 2 lateral flow devices pursuant to the invention made as described above in the EXAMPLES are shown by cutting of polyester-backed nitrocellulose sheet and lamination to cover layer CT. The Type 2 lateral flow devices of FIGS. 11a and 11b comprise different two dimensional candelabra shapes in plan view with fluid-receiving region B and a plurality of arms A where reagent material RS can be deposited as stripes, dots or other configurations to provide a multiplex assay device. The Type 2 lateral flow devices of FIG. 11c comprises a two dimensional star shape in plan view with fluid-receiving region B and a plurality of arms A that terminate with circular testing pads TP where reagent material RS can be deposited as stripes, dots or other configurations to provide a multiplex assay device.

The Type 2 lateral flow devices of FIGS. 11d and 11e comprise two dimensional star shapes in plan view with fluid-receiving region B and a plurality of arms A where reagent material RS can be deposited as stripes, dots or other configurations to provide a multiplex assay device. In FIG. 11e, a cylindrical tube C is attached via glue or other means to the cover tape CT around the via V cut in the cover tape CT to provide a sample reservoir. The diameter of the star shape of FIG. 11d is approximately 1 inch, while the diameter of the star shape of FIG. 11e is approximately ½ inch for comparison.

The Type 2 lateral flow devices of FIGS. 11f and 11g comprise a two dimensional dumb bell shape in plan view with fluid-receiving region B and a plurality of arms A where reagent material RS can be deposited as stripes, dots or other configurations connected to an end wicking region E. The dumbbell two dimensional shape lateral flow device can be useful, for example, in side-to-side comparison of calorimetric test results by the unaided human eye.

Referring to FIGS. 12a, 12b, and 12c further illustrative Type 3 lateral flow devices pursuant to the invention made as described above in the EXAMPLES are shown by laminating the cut two dimensional polyester-backed nitrocellulose shape between cover tapes CT shown as rectangles in these figures. The Type 3 lateral flow device of FIG. 12a comprises a two dimensional candelabra shape in plan view having a fluid-receiving region B with a via V as a fluid inlet and arms A where reagent material can be deposited as stripes, dots or other configurations. The entire outer peripheral cut edge of the candelabra shape is covered by cover layers CT. The Type 3 lateral flow device of FIG. 12b comprises two dimensional star shape in plan view with fluid-receiving region B having via V and a plurality of arms A, A′ where reagent material RS can be deposited as stripes, dots or other configurations to provide a multiplex assay device. Arms A, A′ are of different lengths. The peripheral cut edges CE of the arms A, A′ are exposed at the outer edges of the cover tapes CT, and consequently are in contact with ambient air.

The Type 3 lateral flow devices of FIG. 12c comprises a two dimensional candelabra shape in plan view with fluid-receiving region B and a plurality of arms A and sub-arms SA where reagent material RS can be deposited as stripes, dots or other configurations to provide a multiplex assay device. The end of the base B and the top ends of the sub-arms SA are exposed at the outer edges of the cover tapes CT, and consequently are in contact with ambient air.

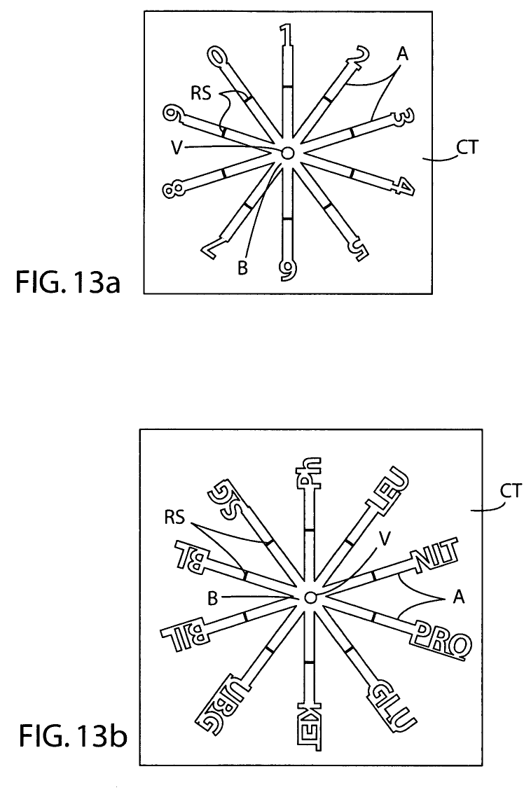

Referring to FIGS. 13a and 13b further illustrate Type 3 lateral flow devices pursuant to the invention made as described above in the EXAMPLES are shown by laminating the cut two dimensional polyester-backed nitrocellulose shape between cover tapes CT shown as rectangles in these figures. The Type 3 lateral flow device of FIG. 13a comprises two dimensional star shape in plan view with fluid-receiving region B having via V and a plurality of arms A where reagent material RS can be deposited as stripes, dots or other configurations to provide a multiplex assay device. The arms A are labelled at their distal ends with the identity symbol of a given test, e.g., test number 1, 2, 3, and so on. The Type 3 lateral flow device of FIG. 13b comprises two dimensional star shape in plan view with fluid-receiving region B with via V and a plurality of arms A where reagent material RS can be deposited as stripes, dots or other configurations to provide a multiplex assay device. The arms A are labelled at their distal ends with the analyte or analyte parameter identity symbol of a given test, e.g., analyte acronyms such as those of a common 10-plex urine dipstick (LEU=leukocytes, NIT=nitrites, PRO=protein, GLU=glucose, KET=ketones, UBG=urobilinogen, BIL=bilirubin, BL=blood, SG=specific gravity).

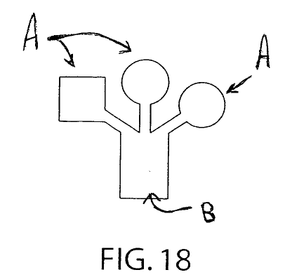

Certain of the Type 2 and Type 3 lateral flow devices described above were subjected to testing as follows: Test protocol involved an artificial urine stock solution was prepared according to Brooks and Keevil [Lett. Appl. Microbiol. 24:203-206 (1997)] and comprised of: 1.1 millimolar lactic acid, 2 millimolar citric acid, 25 millimolar sodium bicarbonate, 170 millimolar urea, 0.4 millimolar uric acid, 7 millimolar creatinine, 2.5 millimolar calcium chloride.2H20, 90 millimolar sodium chloride, 0.005 millimolar iron(II) sulphate.7H20, 2 millimolar sodium sulphate-10H20, 10 millimolar potassium dihydrogen phosphate, 7 millimolar dipotassium hydrogen phosphate, 7 millimolar ammonium chloride, 25 millimolar distilled water, yeast extract, and bacteriological peptone L37, made up to pH 6.5 by addition of hydrochloric acid and then passed through a 0.2 micron nylon membrane filter. Test samples were produced by adding known quantities of glucose and/or albumin to urine stock. Type 2 and 3 lateral flow devices having the shape shown in FIG. 18 were cut from laminar composites comprised of chromatography paper and cover tape, then manually prespotted with conventional calorimetric reagents such as: glucose was detected via the enzymatic oxidation of a chromogen; albumin was detected by the principle of the protein error of indicators as described by Strasinger and DiLorenzo [Urinalysis and Body Fluid Analysis, Saunders: New York, 2nd edition, 2004, pp 123-163]; and pH was assayed by methyl orange. The methyl orange patch was prepared by spotting about 0.1 mL of 7.6 micromolar methyl orange in pH 3 citric buffer on the arm of a device, and allowing the solution to air dry.

Fluid sample was added to Type 2 lateral flow devices by dipping an peripheral cut edge of the device in a pool of fluid sample. Fluid sample was added to Type 3 lateral flow devices by spotting inlet vias with about 0.25 mL of fluid sample. The flow of sample into the devices was spontaneous and immediate. Both types of devices were completely filled within 1-4 min, depending on size of device. Full development of color was complete within an additional 3-4 min.

The lateral flow devices described above are advantageous to reduce operator error by (i) different assays are placed on different arms, thereby improving the spatial discrimination of the user; (ii) arms can be directly labeled (FIG. 13a, 13b); and (iii) the cassette-less format of Type 2 and 3 lateral flow devices eliminates operator error caused by incorrect insertion of test strips into a cassette. Moreover, eliminating the cassette is also important for reducing the cost of test kits, and for rendering strips impervious to external contaminants. In addition, the multiplexed lateral flow devices were fabricated by the computer-controlled X-Y knife plotter, a tool which is commercially available and relatively inexpensive at a cost under US $5,000. The fabricated lateral flow devices were able to draw analyte-containing fluid sample across multiple capture zones (testing regions), without the use of pumps, electricity or other ancillary devices. They offer new strategies for reducing operator error associated with lateral flow tests. Moreover, the technology for laser- and die-based cutting is commercially-available and adapted to the web-based manufacturing methods of conventional diagnostic test strips. Hence there is a facile path to high-volume manufacturing of multiplex assays pursuant to the invention. These devices are of potential benefit to clinicians and patients, especially those in underserved and/or rural communities.

The lateral flow devices are also advantageous in that they can be used to provide a quantitative or semi-quantitative measurement of one or more analytes in a fluid sample as follows.

Step 1. Analyte-capture reagent is deposited and bound at all testing regions TR (e.g. capture zones) of the series of arms A of a two dimensional porous medium layer shape such as the star, candelabra, etc., shape depicted above.

Step 2. Analyte-containing solution is caused to wick past the various testing regions TR (capture zones).

If the amount of analyte which sweeps across the testing region (capture zone) exceeds the total quantity of capture sites of the capture reagent, then the capture zone is saturated, as indicated by maximum development of signal (e.g., calorimetric, emission fluoresence, radioactivity, etc.). However, if the amount of analyte which sweeps across the capture zone is less than the total quantity of capture sites of the capture reagent, then the capture zone signal will be some fraction of the maximum signal. In this latter case, the magnitude of the signal will correlate with the total quantity of sample which passes over the capture line. A preferred embodiment of the invention employs this principle and involves the following steps.

Step 3. The lateral flow device is designed and fabricated such that there is variation in the bed volume of one arm A relative to the next. Bed volume is defined here as the volume occupied by the fluid phase of a fully saturated porous substrate such as nitrocellulose.

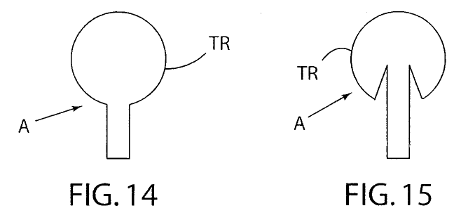

Methods of varying bed volumes are as follows:
(i) cutting the arms to various lengths as shown in FIG. 3b for example where arm A1, A4, A3, and A2 are progressively shorter;
(ii) cutting the arms to various widths;
(iii) cutting the arms to achieve various two-dimensional shapes of varying bed volume, e.g., continuous variation in the total bed volume of quadrilateral arm, fluted arm, lollipop arm (FIG. 14), fractal tree arm, drooping lollipop arm (FIG. 15), etc.
(iv) fabricating porous medium of varying bed thicknesses;
(v) modifying porous medium of uniform bed thickness in a manner which alters the bed porosity;
(vi) coupling one element of porous media of one bed thickness, to one or more separate elements of porous medium of different thicknesses, including the utilization of porous medium of conventional macroscale thicknesses, such as the integration of the conventional adsorbent pads which are used commonly in lateral flow assay fabrication; and
(vii) patterning uncut sheets of porous media with hydrophobic chemicals and/or cover tapes in order to replicate the general structure of a series of fluidically-connected arms whose bed volumes vary by any of the manners above.

By establishing a continuous variation in downstream bed volume in a series of arms, the signal at the testing regions TR (capture zones) will vary from arm to the next, depending on how much analyte, or conversely how much fluid, wicks past the zone.

The volume of sample which is analyzed depends on the bed volume of the porous medium plus whatever solution is lost by evaporation. Hence, in an optional embodiment, evaporative loss is limited or eliminated by capping the porous medium 10 with cover tape CT, as described above for Type 2 or Type 3 lateral flow devices.

For illustrative purposes, the fabrication and operation of a star shaped lateral flow device is described with reference to FIGS. 3a and 16c.

First, a star shape is cut from thin porous medium 10, such as nitrocellulose, with arms of equal width but varying lengths (see arms A1, A2, A3, A4 of FIG. 3a). On each arm, lines of analyte-capture reagent RS are deposited at the same radius, r, from the center of the star, FIG. 16c. The resultant structure is capped with cover tape CT containing hydrophilic adhesive as described for FIG. 16c. An inlet hole or via V for sample entry is provided at the center of the star as described above. Downstream from the capture lines, i.e., towards the periphery of the star shape, the various arms of varying lengths present varying bed volumes. In a preferred illustrative embodiment, the quantity of deposited reagent RS is equivalent from one arm to the next, and always exceeds the total number of analyte molecules which might wick past any given testing region TR (capture zone). Upon fabricating the star shape, the various arm lengths are adjusted so that:
(i) at least one arm is too short to produce a detectable signal;
(ii) the remaining arms are of lengths which produce detectable signals (a) less than the maximum signal, and (b) continuously varying from, ideally, near zero to near maximum.

Optionally, the quantity of deposited reagent on each arm may be fixed such that one or more arms produce the maximum signal due to the saturation of all available binding sites of those one or more capture zones.

Readout of signal is performed by various standard means, such as the unaided human eye in the case of calorimetric assays, or by various machine-based detection methods such as those based on electrochemistry, radiochemistry, magnetochemistry, etc. Optionally, by appropriate mathematical techniques, the digitized signals from the various testing regions TR (capture zones) are used to compute the unknown quantity of analyte in a given sample of interest by comparison with a pre-established look-up table of known values.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential.

Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed.

Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

1. A lateral flow device, comprising a porous medium layer having a two-dimensional shape in plan view defined by one or more peripheral edges of the porous medium layer wherein the two dimensional shape includes a plurality of fluid testing regions separated from one another by intervening spaces between portions of the one or more peripheral edges and further having a fluid-receiving region in capillary flow communication through the porous medium layer to the testing regions.

2. The device of claim 1 wherein the fluid testing regions comprise elongated arms.

3. The device of claim 1 wherein the testing regions include a respective bioreagent, immunological reagent, or chemical reagent for detecting the presence or absence of an analyte.

4. The device of claim 1 having a cover layer on one side of the porous medium layer.

5. The device of claim 4 wherein the cover layer includes a fluid inlet region in communication with the fluid-receiving region.

6. The device of claim 1 having a cover layer on each of the opposite sides of the porous medium layer with portions of the cover layer occupying the intervening spaces.

7. The device of claim 6 wherein one cover layer includes a fluid inlet region in communication with the fluid-receiving region.

8. The device of claim 6 wherein a portion of the porous medium layer is exposed at the peripheral severed edge thereof.

9. The device of claim 1 wherein the fluid flows from the fluid-receiving region by capillary action through the porous medium layer toward each of the plurality of testing regions where a plurality of assays can be performed on the fluid sample.

10. The device of claim 1 wherein the porous medium layer has a star shape in plan view with a fluid-receiving region and a plurality of arms extending from the fluid-receiving region and terminating in a plurality of remote testing regions to which fluid flows by capillary action.

11. The device of claim 10 wherein the star shape has “n” number of arms and wherein “n” number of assays can be performed on the arms on one fluid sample.

12. The device of claim 11 wherein the star shape has four arms arranged 90 degrees from one another about the fluid sample-receiving and wherein four assays can be performed on the arms on one fluid sample.

13. The device of claim 11 wherein the star shape has eight arms arranged 45 degrees from one another about the fluid sample-receiving to form a branched star shape and wherein eight assays can be performed on the arms on one fluid sample.

14. The device of claim 11 wherein each arm of the star shape includes a plurality of branches forming a plurality of sub-arms extending from a respective arm to which fluid flows by capillary action.

15. The device of claim 14 wherein the star shape includes a plurality of “m” sub-arms and wherein “m” number of assays can be performed on the sub-arms on one fluid sample.

16. The device of claim 11 wherein each arm of the star shape includes a plurality of branches forming a plurality of sub-arms extending from a respective arm and wherein the sub-arms each has a plurality of secondary sub-arms extending therefrom to which fluid flows by capillary action.

17. The device of claim 16 wherein the star shape includes a plurality of “p” secondary subarms and wherein “p” number of assays can be performed on the secondary sub-arms on one fluid sample.

18. The device of claim 1 wherein the porous medium layer has a candelabra shape in plan view with a fluid-receiving base and a plurality of candelabra arms connected to the base to which fluid flows by capillary action.

19. The device of claim 18 wherein each candelabra arm includes a plurality of sub-arms.

20. The device of claim 19 wherein the candelabra shape includes a plurality of “r” sub-arms and wherein “r” number of assays can be performed on the sub-arms on one fluid sample.

21. The device of claim 1 wherein the porous medium layer has a double candelabra shape in plan view with first fluid-receiving base connected to a plurality of candelabra arms which are connected to one another and to a second base and wherein fluid flows from the first fluid sample-receiving base and through the candelabra arms to the other of the first and second bases by capillary action.

22. The device of claim 1 wherein the indicator regions include a two dimensional test number in plan view thereof.

23. The device of claim 1 the indicator regions include a two dimensional acronym for an analyte in plan view thereof.

24. The lateral flow device of claim 1 wherein the porous medium layer comprises nitrocellulose or paper.

25. A method of making a lateral flow device, comprising:
(a) laminating a cover layer to a layer of porous medium to form a laminar composite, and
(b) severing the laminar composite through the thickness of the cover layer and the thickness of the layer of porous medium to form one or more lateral flow structures each having a porous medium layer with a two-dimensional shape in plan view defined by one or more peripheral severed edges wherein the two dimensional shape includes a plurality of testing regions separated from one another by intervening spaces between portions of the one or more peripheral severed edges and further each having a fluid-receiving region in capillary flow communication through the porous medium layer to the indicator regions.

26. The method of claim 25 including the step of depositing a bioreagent, immunological reagent, or chemical agent at each of the testing regions of the two dimensional shape before step (a).

27. A method of making a lateral flow device, comprising:
(a) making a disposable cover layer comprising a plastic sheet having adhesive thereon,
(b) laminating the disposable cover layer to a layer of plastic-backed porous medium, wherein the adhesive-bearing side of the disposable cover layer is mated to the porous-medium-bearing side of the plastic-backed porous medium to form a laminar composite,
(c) cutting the laminar composite through the plastic-backing of the porous medium and through the porous medium to form ready-to-release lateral flow structures, and
(d) releasing the lateral flow structures from the disposable cover layer.

28. The method of claim 27 including segregating the lateral flow structures from unwanted areas of plastic-backed porous-medium.

29. A method of making a lateral flow device, comprising:
(a) laminating a cover layer to opposite sides of a porous medium layer that is cut to have a two-dimensional shape in plan view defined by one or more peripheral severed edges wherein the two dimensional shape includes a plurality of testing regions separated from one another by intervening spaces between portions of the one or more peripheral severed edges, wherein the porous medium layer has a fluid-receiving region in capillary flow communication with the testing regions, and
(b) providing a fluid access to the fluid-receiving region of the porous medium layer.

30. The method of claim 29 wherein fluid access is provided by forming a fluid inlet in one of the cover layers and communicated to the fluid-receiving region.

31. The method of claim 30 wherein fluid access is provided by exposing a portion of the cut edge of the porous medium layer to receive the fluid.

32. The method of claim 31 wherein the cut edge portion is exposed by removing one of the cover layers.

33. The method of claim 32 wherein the edge portion is exposed by not covering it with the cover layers when the cover layers are laminated to the porous medium layer.

34. A method of making a lateral flow device, comprising:
(a) making a first laminar composite having a plastic layer having first and second release liner layers adhered on opposite sides thereof,
(b) winding the first laminar composite as a web on a first spool,
(c) making a second laminar composite having a porous medium backed by a plastic layer,
(d) winding the second laminar composite as a web on a second spool,
(e) unwinding simultaneously the first laminar composite and the second laminar composite from the respective first spool and the second spool,
(f) removing one of the first or second release liner layer from the first laminar composite, leaving a modified first laminar composite having the plastic layer with a hydrophillic adhesive exposed on one of the opposite sides and the other of the first or second release liner layer still residing on the other of the opposite sides,
(g) mating the modified first laminar composite and the second laminar composite so that the porous-medium-bearing side of the second laminar composite is mated to the hydrophilic-adhesive-bearing side of the modified laminar composite, resulting in a collective laminar composite, and
(h) cutting the collective laminar composite to form lateral flow structures having a two dimensional shape in plan view defined by one or more peripheral cut edges.

35. The method of claim 34 wherein step (h) involves cutting the two-dimensional shape in plan view defined by the one or more peripheral cut edges wherein the two dimensional shape includes a plurality of testing regions separated from one another by spaces between portions of the one or more peripheral cut edges, wherein the porous medium layer gas a fluid-receiving region in capillary flow communication with the indicator regions.

36. The method of claim 34 further including the step of dispensing a bioreagent or chemical agent on the indicator regions of the lateral flow structures before or after they are cut.
